(19) United States
(12) Patent Application Publication
(10) Pub. No.: US 2019/0138576 A1
(43) Pub. Date: May 9, 2019

(54) METHOD FOR VISUALIZING RESULTS OF ANALYSES OF CAD/CAM DATA

(71) Applicant: HEIDELBERGER DRUCKMASCHINEN AG, HEIDELBERG (DE)

(72) Inventors: HARTWIG BOLLE, DUDENHOFEN (DE); WERNER GENTHNER, ROSSDORF (DE); CHRISTOPH RUPPERT, WIESLOCH (DE)

(21) Appl. No.: 16/164,037

(22) Filed: Oct. 18, 2018

(30) Foreign Application Priority Data
Nov. 6, 2017 (DE) 10 2017 219 631.9

(51) Int. Cl. G06F 17/22; G06F 17/50

(52) U.S. Cl. CPC G06F 17/2235; G06F 17/2264; G06F 17/50

(57) ABSTRACT

A method for visualizing analysis results of CAD/CAM data on a screen includes a first step of extracting specific report data using a computer system from CAD/CAM data based on rules predefined or composed by an operator, combining the extracted report data in report(s) and saving the data on the computer system. In a second step, saved extracted report data are analyzed by the computer system according to rules predefined or desired by the operator and edited for visual display on the screen and/or text search using search tools and saved on the computer system. In a third step, report data edited for visualization and/or a text search are correlated with the CAD/CAM data by the computer system, analysis results of the visual editing or text search are linked to the CAD/CAM data and results of the linking are represented on the screen.

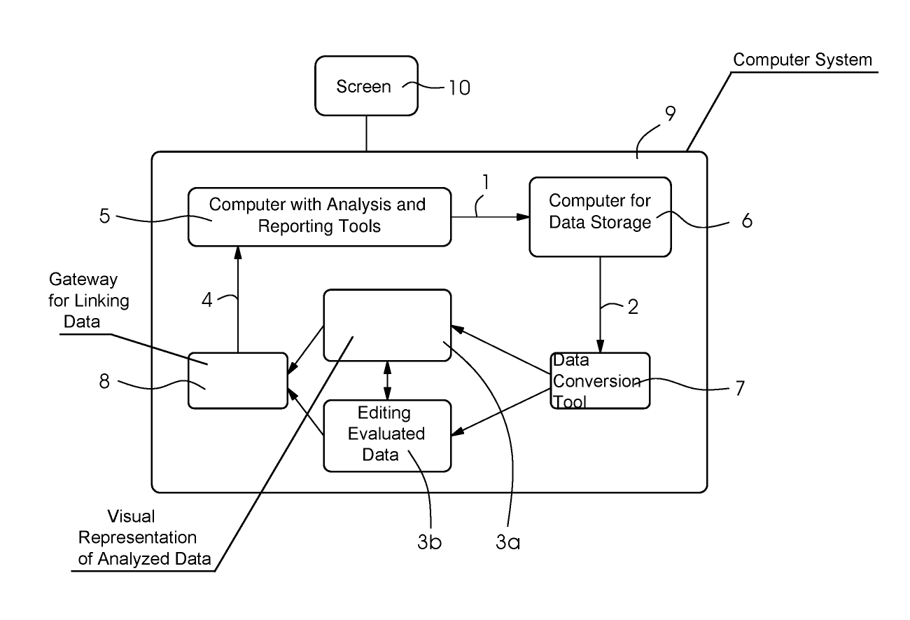

### CROSS-REFERENCE TO RELATED APPLICATION

This application claims the priority, under 35 U.S.C. § 119, of German Patent Application DE 10 2017 219 631.9, filed Nov. 6, 2017; the prior application is herewith incorporated by reference in its entirety.

### BACKGROUND OF THE INVENTION

### Field of the Invention

The present invention relates to a method for visualizing results of analyses of CAD/CAM data on a screen by using a computer system wherein, in a first step, report data are specifically extracted from CAD/CAM data by the computer system using rules that have been pre-defined or composed by an operator and the extracted report data are combined in one or more reports and saved on the computer system, and in a second step, the extracted report data that have been saved are analyzed by the computer system in accordance with rules that have likewise been pre-defined or selected by the operator and are prepared for being visually displayed on the screen and/or for text search by using search tools and saved on the computer system.

Methods of that general type are used in CAD/CAM data analyses to give an operator access to desired information from CAD drawings and CAM documents. That is done by software that analyses CAD/CAM data. Such software is marketed by Heidelberger Druckmaschinen AG under the name Heidelberg CAx Quality Manager. The combined rules or pre-defined rules are saved in a so-called big data check suite with invariably defined standard checks. The operator may use that check suite to search for specific information such as specific dimensions in CAD/CAM files. Then the software saves the results as report data in one or more reports. The report data may be saved in one or more files, in one or more databases, or in a cloud. The report files are generated in a specific data format such as XML or JSON. In general, before the extracted report data may be displayed on a screen or prepared for a text search, an intermediate step is required in which the extracted report data are converted to a suitable data format of the analysis software for visualization and/or text search. For that purpose, the Heidelberg CAx Quality Manager software has a module called HQM Big Data Converter, which converts the extracted report data into a format that may be graphically edited using Microsoft Excel or Microsoft Power BI. The text search is done using search engines such as Google or the like.

In accordance with the prior art, the data analysis is completed with the visual representation on the screen or the preparation for a text search. In practice, however, the operator would like to have the results of the analysis displayed directly in terms of their effects on the objects of the CAD/CAM files. However, that is impossible when using the current Heidelberg CAx Quality Manager software.

### SUMMARY OF THE INVENTION

It is accordingly an object of the invention to provide a method for visualizing analysis results of CAD/CAM data, which overcomes the hereinafore-mentioned disadvantages of the heretofore-known methods of this general type and with which an operator may see the analysis results in the immediate context of components of the CAD/CAM data.

With the foregoing and other objects in view there is provided, in accordance with the invention, a method for visualizing analysis results of CAD/CAM data on a screen by using a computer system wherein:

in a first step, specific report data are extracted by the computer system from CAD/CAM data based on rules that have been pre-defined or composed by an operator, the extracted report data are combined in one or more reports, and saved on the computer system;

in a second step, the saved extracted report data are analyzed by the computer system likewise in accordance with rules that have been pre-defined or desired by the operator and are edited for being visually displayed on the screen and/or for a text search by using search tools and are saved on the computer system; and

in a third step, the report data that have been edited for visualization and/or text search are correlated with the CAD/CAM data by the computer system and analysis results of the visual editing or text search are linked with the CAD/CAM data and the results of the linking are displayed in a suitable way on the screen.

In accordance with the invention, the visualization method includes a further step in which a computer correlates the report files that have been edited for visualization and/or text search with the CAD/CAM data, thus linking analysis results of the visual editing or test search with the CAD/CAM data. In this way, the user may have the analysis results displayed on the screen with a direct reference to the CAD/CAM data. If the operator has chosen a reporting in which the CAD/CAM files are represented and analyzed in terms of all components made of a specific material, for instance, every component made of the material in question is indicated in the CAD/CAM files by a red mark, for instance. In this way, the operator is given a quick indication of the components in the CAD/CAM files that are made of the material that has been defined. In the same way, the operator may have the report data analyzed in terms of where components are very frequently repaired. In accordance with the specifications provided by operator, the CAD/CAM components that are frequently repaired are marked in red. Thus, the operator is not merely shown statistical analysis data that give him or her statistical information on the components in question, but rather is given a chance to have the relevant components graphically pointed out to him or her in the CAD/CAM system by a suitable indicator. In this way, the loop from analyzing the extracted report data to the CAD/CAM files in the CAD/CAM system is closed and a direct link is provided to the user.

In a first embodiment of the invention it is envisaged that the computer system includes multiple computers, in particular computers connected by a network. The method of the invention runs on a computer system that may be formed a single computer. In this case, the CAD/CAM system, the memory space for the extracted report data, the programs for analyzing data, and the software for generating the links between the analysis results and the CAD/CAM data are present on one computer. In practice, however, at least the CAD/CAM system will in most cases be present on a separate computer whereas the extracted report data are saved on a different computer, in particular in a database or cloud. In most cases, the analysis and text search will be carried out on a further computer. In this case, at least three computers are interconnected by a network such as an intranet or the internet. This means that the computers may be at different locations. The computers merely need to be linked to form the computer system.

Advantageously, it is envisaged that the CAD/CAM data describe components or component groups of machinery and that in the first step, component sizes such as bore dimensions, thread data, weight data, tolerances, texts, tables or parts lists are extracted from the CAD/CAM data. The present invention is particularly suited for obtaining specific information on components or component groups of complex machinery. Printing machines, for instance, include thousands of mechanical components that have specific dimensions, thread data, weight data, tolerances, and materials. In order to be able to group these components or groups of components as desired in terms of their characteristics and thus to obtain a general impression of the various variations of components or groups of components, it is advantageous to search for construction features such as bore dimensions, thread data, weight data, tolerances, or other descriptions when the report data are extracted. The corresponding report data are then available for analysis by analyzing tools and search engines. Thus, it becomes possible to edit the extracted report data for visualization in a further step and to display them on the screen in the form of tables or graphics. In addition, it is possible additionally or alternatively to submit the extracted report data to a text search to be able to obtain specific information in particular from texts, tables, or parts lists on the CAD drawings.

In a particularly advantageous embodiment of the present invention, it is envisaged that a link is saved on the computer system with the report data at every stage of the method, with the link containing the source of the report data on the CAD/CAM data. This is a way to ensure that at every point of the method of the invention, the report data are linked with the original CAD/CAM data, allowing the analysis results subsequently likewise to be allocated to the respective CAD/CAM data and thus closing the loop back to the CAD/CAM data. Thus, it is possible for the computer system to access the CAD/CAM data and to create a link between the report data that have been edited for visual representation and/or for a text search and the data from the CAD/CAM system.

In a further embodiment of the present invention it is envisaged that the link is achieved via a server of the computer system on which the CAD/CAM data are loaded when the CAD/CAM system is started and which provides access to the CAD/CAM data. In this case, it is not necessary to include links to all report data at every point of the method of the invention; instead, it is sufficient if a server that co-protocols the accessed CAD/CAM files and provides access to the CAD/CAM data at all points is automatically started at the beginning of the method when the CAD/CAM data of the CAD/CAM system are first accessed. When commands to access the CAD/CAM data are input after the data analysis or text search, the server ensures that these commands are implemented on the suitable CAD/CAM data that fit the analysis results.

In this context, a particularly advantageous embodiment of the invention envisages a third step in which the operator modifies the representation of the CAD/CAM data on the screen by using operator commands on the basis of the report data that have been edited for visualization and/or text search. In this way, all components or groups of components that have a bore of a specific diameter may be marked by a specific color in the CAD/CAM data. Another command is to zoom into corresponding CAD/CAM data or to display components that have been frequently changed or repaired if the query was aimed at the frequency of exchanges or repairs of components.

Other features which are considered as characteristic for the invention are set forth in the appended claims.

Although the invention is illustrated and described herein as embodied in a method for visualizing results of analyses of CAD/CAM data, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE of the drawing is a flow diagram providing an overview of all software and hardware components that contribute to the method of the invention for visualizing analysis results of CAD/CAM data.

### DETAILED DESCRIPTION OF THE INVENTION

Referring now in detail to the single FIGURE of the drawing, it is seen that the method of the invention for visualizing results of analyzing CAD/CAM data runs on a number of computers that are interconnected by a network. A computer 5 including analysis and reporting tools and having access to CAD/CAM files is provided. The CAD/CAM files are stored thereon. This computer 5 has software that may search CAD/CAM files in accordance with rules defined by the operator or default rules to generate reports on component groups, components, and drawings. Such software is marketed by Heidelberger Druckmaschinen AG under the name of Heidelberg CAx Quality Manager. It contains suitable analysis and reporting tools that may extract native CAD/CAM data and generate corresponding report data in a first step 1. In a next step 1, these extracted report data are saved, for instance in a database on a further computer 6 for data storage. The report data are preferably stored in an XML or JSON data format. On a further computer, a data conversion tool 7 is provided to convert the extracted report data on the computer 6 into formats for analysis by software such as Microsoft Excel or Microsoft Power BI. For this purpose, the report data are converted from an XML format to a CSV format, for instance. This step 2 of editing and converting data into suitable big data analysis formats is a pure data conversion step. The actual analysis is made in steps 3a and 3b, which include a visual representation on a screen 10, for instance using Microsoft Excel. Steps 3a and 3b may be carried out anew on a separate further computer of the computer system. Alternatively, they may be carried out on computer 5 or computer 6. In this process, the data is graphically edited and displayed in Microsoft Excel tables or graphics. A graphic representation of analyses is likewise possible in Microsoft Power BI. In step 3b, the data are edited in such a way that they are suitable for interactive and automated further processing in text searches. For this purpose, the data may be transferred to databases and processed by a search engine such as Google.

In accordance with the invention, it is possible for the results of the data analysis to be displayed in terms of the actual CAD/CAM data of the CAD/CAM system in a further step 4. This step 4 includes operator's commands such as load CAD/CAM data, enlarge, minimize, mark by color, and in particular indicate components or groups of components that need frequent repairs or changes. For this purpose, software 8 is provided that acts as a gateway to linking analyzed data with the original data from the CAD/CAM system. In this way, the analyzed data may be made available directly in the CAD/CAM system to be further processed and reviewed by other employees.

In the FIGURE, this is done by generating http links during the analyzing of the report data and displaying them in the analyses. The link includes a URL with important information such as host name, port number, this is computer 5 on which the CAD/CAM data are to be interactively reviewed or processed, as well as information on the component or object that is to be loaded and processed. It includes information that refers to the application mode such as 3D modeling or 2D drawing. The link likewise contains information on the object that is to be displayed, enlarged, minimized, marked or processed. In addition, the link contains information on the CAD/CAM system, for instance NX made by Siemens, that accesses the data. The data are saved in a file system or in a PLM system such as TeamCenter or SAP PLM. So-called teamcenters are indicated if the data are administrated in the TeamCenter system by Siemens. If SAP data are used, the information is administrated using the CAD/CAM interface ECtr/FCtr in SAP.

The gateway 8 for linking analyzed data with the original data contains multiple software components: an internal web server for receiving and analyzing the aforementioned http link on one hand and a client for communicating with a running CAD/CAM session through a remote connection and for continuously monitoring the status of the running CAD/CAM session on the other hand. In addition, a DLL file “HQM Remote Server” is used for the CAD system in NX manufactured by Siemens. It includes a server that is co-loaded when the CAD system is started and thus provides remote access to the CAD/CAM session per http. In this process, the gateway 8 receives the link from the internal web server, analyzes it and transmits the commands to be implemented to the internal client. The client in the gateway 8 contacts the server part “HQM Remote Server” running in the CAD/CAM session, thus gaining remote access to the running CAD/CAM session. The client may then implement commands to open the component, change the module (3D to 2D or vice versa), zoom, select, modify, mark, etc. in the objects of the CAD/CAM files. In this way, the gateway 8 allows a direct linking of the results of the visual analysis or text search in search engines in steps 3a and 3b with the CAD/CAM data.

The following is a summary list of reference numerals and the corresponding structure used in the above description of the invention:
1 analysis and reporting method to extract CAD/CAM data
2 data editing and conversion into suitable big data analysis formats
3a visual representation of analyzed data
3b editing of the evaluated data for text-based search systems
4 representation or correction of the analyzed data in the CAD/CAM system
5 computer including analysis and reporting tools with access to CAD/CAM file
6 computer for data storage
7 data conversion tool
8 gateway for linking analyzed data with original data from the CAD/CAM system
9 computer system
10 screen

1. A method for visualizing analysis results of CAD/CAM data on a screen by using a computer system, the method comprising the following steps:
in a first step, using the computer system to extract specific report data from CAD/CAM data based on rules having been pre-defined or composed by an operator, combining the extracted report data in one or more reports, and saving the extracted report data on the computer system;
in a second step, using the computer system to analyze the saved extracted report data in accordance with rules having been pre-defined or desired by the operator, to edit the extracted report data for at least one of being visually displayed on the screen or for a text search by using search tools and to save the extracted report data on the computer system; and
in a third step, using the computer system to correlate the report data having been edited for at least one of visualization or text search with the CAD/CAM data and linking analysis results of the visual editing or text search with the CAD/CAM data and suitably displaying results of the linking on the screen.

2. The method according to claim 1, which further comprises carrying out a further step, between the first and second steps, of processing the extracted report data by using a data converter on the computer system for following steps.

3. The method according to claim 1, which further comprises saving the extracted report data in a file, a database or a cloud after the first step.

4. The method according to claim 1, which further comprises providing the computer system with a plurality of computers or computers connected by a network.

5. The method according to claim 1, wherein the CAD/CAM data describe components or component groups for machinery, and the first step includes extracting component features including bore dimensions, thread data, weight data, tolerances, texts, tables, or parts lists from the CAD/CAM data.

6. The method according to claim 1, which further comprises displaying the report data on the screen as tables or graphics in the second step of editing for visualization.

7. The method according to claim 1, which further comprises saving a link containing a source of the report data from the CAD/CAM data on the computer system with the report data at every step of the method.

8. The method according to claim 1, which further comprises, in the third step using the computer system to access the CAD/CAM data and create a link between the report data having been edited for at least one of visual representation or a text search and a CAD/CAM system.

9. The method according to claim 8, which further comprises implementing the link through a server of the computer system, the server being loaded with the CAD/CAM data when the CAD/CAM system with the CAD/CAM is started and the server being providing access to the CAD/CAM data.

10. The method according to claim 9, which further comprises using the computer system to analyze the link of the server and linking the link with commands to be executed to access the CAD/CAM data.

11. The method according to claim 1, which further comprises providing operator commands based on the report data having been edited for at least one of visualization or a text search to be used by the operator to modify the representation of the CAD/CAM data on the screen in the third step.
